(19) United States
(12) Patent Application Publication
(10) Pub. No.: US 2002/0067253 A1
(43) Pub. Date: Jun. 6, 2002

(54) Method and apparatus for the display of alarm information on a portable device

(75) Inventors: Miroslav Trajkovic, Ossining, NY (US); Srinivas Gutta, Buchanan, NY (US)

Correspondence Address: Corporate Patent Counsel, U.S. Philips Corporation, 580 White Plains Road, Tarrytown, NY, 10591, US

(73) Assignee: Philips Electronics North America Corporation

(21) Appl. No.: 09/728,054

(22) Filed: Dec. 1, 2000

(51) Int. Cl. G08B 29/00

(52) U.S. Cl. 340/506; 340/407.1; 340/426; 340/541

(57) ABSTRACT

An alarm system having an alarm portion and a portable device. The portable device has a form-factor of a key. The key wirelessly receives alarm status information from the alarm portion and displays an alarm status indication in response to the received alarm status information. The key utilizes a processor connected to a memory, a display, and a status inquiry actuator. The memory stores control/display data. The processor queries the memory to retrieve corresponding control/display data in response to the received alarm status information. The processor utilizes the retrieved control/display data to produce the alarm status indication. The status inquiry actuator enables a user to make an alarm status inquiry. The processor displays the alarm status indication in response to the alarm status inquiry. The portable device utilizes a transmitter to transmit the alarm status inquiry to the alarm portion. The alarm portion then queries one or more monitoring devices to determine a current alarm monitoring status. Thereafter, the alarm portion transmits the current alarm monitoring status to the portable device.

### FIELD OF THE INVENTION

This invention generally relates to a method and apparatus for providing a user with alarm status information in a simple way on a portable device. Specifically, the present invention pertains to utilizing a wireless communication system to transmit alarm status information to a portable device.

### BACKGROUND OF THE INVENTION

In the prior art, there are alarm systems that exist in both homes and automobiles that can detect changes in an alarm's monitoring status. The monitoring status may simply be whether the alarm is set or not, or may be as complex as the specific status of one or more monitoring devices. For instance, a home alarm system may have a multitude of different monitoring devices such as a door/window contact switch, a break glass sensor, a motion detector, a flood detector, a fire detector, a smoke detector, proximity detector, etc. Home alarm systems have the ability to detect a change in status for each of the above monitoring devices and in many cases may be able to differentiate between each device for the purpose of communicating meaningful alarm status information to the user. Automobile alarm systems also may have a multitude of similar monitoring devices, each of which may indicate a different alarm condition.

However, both the home alarm system and the automobile alarm system have a common problem in that they are limited in their ability to communicate an alarm status or a change in alarm status to a user that is not located in the near proximity of the alarm system.

Home alarm systems typically have a connected display that can communicate alarm status information to a user. This is very useful when the user is located at the site where the alarm system is connected but is of no use to a user that is remotely located. Home alarm systems further have the ability to communicate an alarm condition to a central monitoring station using either a wireless or wired telephone system. However, with a home alarm system, alarm status information can not be readily communicated to the user without manual intervention. Specifically, home alarm status information must be communicated to the user by persons at the central monitoring station who, in practice, may call the user to inform the user of the alarm condition.

Automobile alarm systems typically have a light emitting diode (LED), or other indicator lamp, and an auditory indicating device that may communicate the automobile alarm systems status. For instance, the automobile alarm system may communicate a single beeping sound and may flash the LED in a continuous sequence of single flashes to indicate that the automobile alarm system has been set. Similarly, the automobile alarm system may communicate a double beeping sound and may flash the LED in a continuous double flashing sequence to indicate that the automobile alarm system has been disarmed. Further, the automobile alarm system may communicate a triple beeping sound and may flash the LED in a continuous triple flashing sequence to indicate that the automobile alarm system has been set off in response to a change in detector status of one or more of the automobile monitoring devices. However, both the home alarm system and the automobile alarm system are limited in their ability to communicate alarm status information to a user that is located away from the alarm system.

Accordingly, it is an object of the present invention to overcome the disadvantages of the prior art.

### SUMMARY OF THE INVENTION

These and other objects of the present invention are achieved by an alarm system that utilizes an alarm portion and a portable device. The portable device may have the form-factor of a key. In operation, the key wirelessly receives alarm status information from the alarm portion and displays an alarm status indication in response to the received alarm status information. The key may have a processor connected to a memory, a display, and a status inquiry actuator. The memory may store control/display codes. The processor, in response to the received alarm status information, queries the memory to retrieve corresponding control/display codes. The processor utilizes the retrieved control/display codes to produce the alarm status indication. The status inquiry actuator enables a user to make an alarm status inquiry. The processor displays the alarm status indication in response to the alarm status inquiry.

In one embodiment in accordance with the present invention, the portable device (e.g., key) may utilize a transmitter to transmit the alarm status inquiry to the alarm portion. The alarm portion may then query the monitoring devices to determine the current alarm monitoring status or may just recall stored alarm monitoring status. Thereafter, the alarm portion transmits the current alarm monitoring status to the portable device. In another embodiment, the alarm portion may continue to transmit alarm status information to the portable device until the portable device transmits a signal confirming receipt of the alarm status information.

In another embodiment, the portable device may utilize a vibration/auditory device to alert a user by vibrating and/or producing an auditory indication in response to the received alarm status information.

### BRIEF DESCRIPTION OF THE DRAWINGS

The following are descriptions of embodiments of the present invention that when taken in conjunction with the following drawings will demonstrate the above noted features and advantages, as well as further ones. It should be expressly understood that the drawings are included for illustrative purposes and do not represent the scope of the present invention. The invention is best understood in conjunction with the accompanying drawings in which:

FIG. 1 shows an illustrative alarm system in accordance with an embodiment of the present invention;

FIG. 2 shows details of a portable status displaying device in accordance with an embodiment of the present invention; and

FIG. 3 shows an illustrative flow diagram of an embodiments operation in accordance with the present invention.

### DETAILED DESCRIPTION OF THE INVENTION

In the discussion to follow, certain terms will be illustratively discussed in regard to specific embodiments or systems to facilitate the discussion. For example, the present invention will be illustratively discussed in terms of an automobile alarm system and other corresponding portions thereof. However, as would be readily apparent to a person of ordinary in the art, these terms should be understood to encompass other similar applications and embodiments wherein the present invention may be readily applied. Accordingly, the features should be understood to apply to any system wherein it would be desirable to remotely convey detailed status information of a monitoring device and alarm portion to a person utilizing a simple and readily portable status displaying device, or simply, a portable device. In the embodiment shown, the portable device has a form-factor that does not require a user to carry an additional, dedicated displaying apparatus.

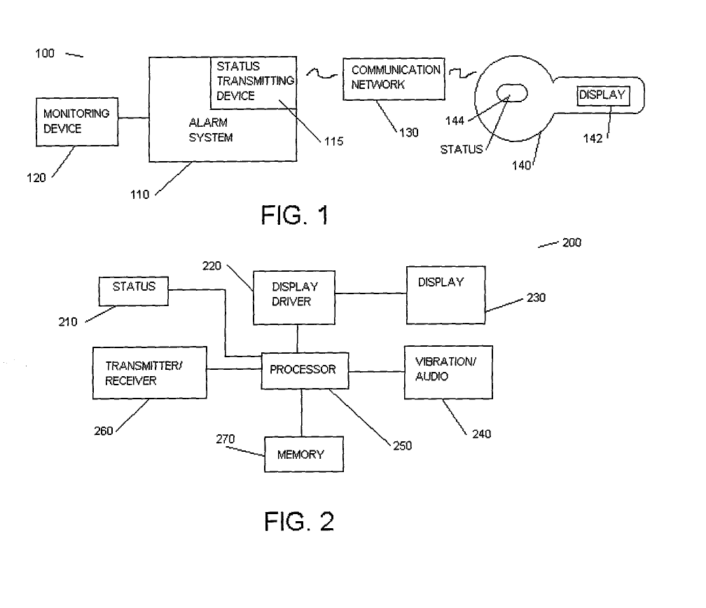

FIG. 1 depicts an illustrative system 100 in accordance with an embodiment of the present invention. The system 100 contains an alarm portion 110 coupled to one or more monitoring devices 120. The alarm portion 110 may be coupled to the monitoring device 120 via a wired or wireless communication medium. The alarm portion 110 is also coupled to a portable device 140, in the form-factor of a key 140. The key 140 is an ideal portable device since the key 140 may already be required by the user for arming/disarming and locking/unlocking the corresponding alarm portion 110 and an entry door (not shown), such as when the alarm portion 110 is installed in an automobile (not shown).

The alarm portion 110 is shown operatively coupled to the key 140 via a communication network 130 and a status transmitting device 115. The communication network 130 may contain portions of a wired telephone network (e.g., POTS), a wireless telephone network, a cellular telephone network, a pager network, an internet or other network type connection, etc. . . . In fact, any other known system that has the ability of receiving status information from the alarm system 110 and that can thereby, wirelessly transmit the alarm status information to the key 140, may be utilized in accordance with the present invention.

In one embodiment in accordance with the present invention, the communication network 130 may also operate in transmitting a status inquiry from the key 140 to the alarm portion 110. In this embodiment, the key 140 may also contain an alarm status inquiry actuator 144 for enabling a user to query the alarm portion 110. This may be useful when the user believes that he or she may have been located such that alarm status information (e.g., a change in alarm status information) was not receivable by the key 140. For example, it is known that wireless communications are difficult when a user is located within an elevator. Accordingly, a user may wish to make an alarm status inquiry after the user has exited the elevator. In these embodiments, the status transmitting device 115 also acts to receive alarm status inquiries from the key 140 via the communication network 130.

In other embodiments, the communication network 130 may continuously, for a given period of time, transmit a change in alarm status information to the key 140. In other embodiments, the communication network 130 may continue to transmit, either continuously or periodically, change in alarm status information until the key 140 transmits a signal to the communication network 130 confirming receipt of the change in alarm status information. In yet other embodiments, the alarm portion 110 may continue to transmit, either continuously or periodically, change in alarm status information until the key 140 transmits a signal to the alarm portion 110, via the communication network 130, confirming receipt of the change in alarm status information.

In accordance with the present invention, the monitoring device(s) 120 may detect fault conditions that occur at the monitored location. Illustratively, the alarm portion 110 and the monitoring device(s) 120 may be installed within an automobile. In this way, a user may remotely monitor the alarm status at the automobile via the key 140. To further this goal, the key 140 has a display 142. The display 142 may be a liquid crystal display (LCD), a light emitting diode display (LED), or any other known type of display that may be utilized to display details of the alarm portions 110 alarm monitoring status.

For an automobile, the monitoring device(s) 120 may monitor different entry points on the automobile such as one or more doors, a trunk, and a hood of the automobile. In addition, the monitoring device(s) 120 may monitor the position of a retractable roof. Further, the monitoring device(s) 120 may detect other conditions of the automobile such as whether the automobile has sustained an impact, or whether a cracking sound was detected within the automobile such as may occur when a window is broken by an intruder. The monitoring device(s) 120 may also monitor whether a flooding condition has occurred within the vehicle.

In one embodiment in accordance with the present invention, one or more of the monitoring device(s) 120 may detect each of these separate conditions. In a particular embodiment, the alarm portion 110 may distinguish between different status conditions of one or more of the monitoring device(s) 120. For instance, the alarm portion 110 may be able to distinguish between whether a change in alarm monitoring status has occurred due to a broken window detected by a break-glass monitoring device 120 or whether an open door was detected by a pin switch monitoring device 120. In this way, the alarm monitoring portion 110 may convey to the key 140, different information indicating the different changes in alarm monitoring status that may occur.

FIG. 2 shows the details of a portable device, such as a key 200, in accordance with an embodiment of the present invention. Illustratively, the key 200 contains a processor 250. The processor 250 may be a dedicated processor for operation in accordance with the present invention, or it may be a general processor that operates in accordance with the present invention as only one of a plurality of other operations. For example, the processor 250 may also operate together with an automobile locking and starting system to deter unauthorized use of the automobile as is known in the art. The processor 250 may also be a dedicated integrated circuit that is configured for operation in accordance with the present invention as discussed in more detail herein.

The processor 250 is coupled to a transmitter/receiver 260, a memory 270, a vibration/audio alert 240, and a status inquiry actuator 210. The processor 250 is also coupled to a display 230 via a display driver 220. The memory 270 may contain a look-up table of control/display codes to control the processor 250 and for the processor 250 to provide to the display driver 220. The control/display codes may be a series of processor instructions, such as a program or program portion, which control the operation of the processor 250 and may thereby in addition, cause the display 230 to display alarm status information. Further, the control/display codes may control the processor 250 to provide a vibration and/or audio indication to a user via the vibration/audio alert 240 to indicate a change in alarm monitoring status. As would be readily apparent to a person of ordinary skill in the art, although the portions of key 200 are shown as separate operational blocks, clearly these blocks may be combined into a single or multiple combinations of integrated circuits. This combination of operational blocks may be desirable for the purpose of minimizing the size of the operational blocks and/or for reducing the power consumption of the operational blocks.

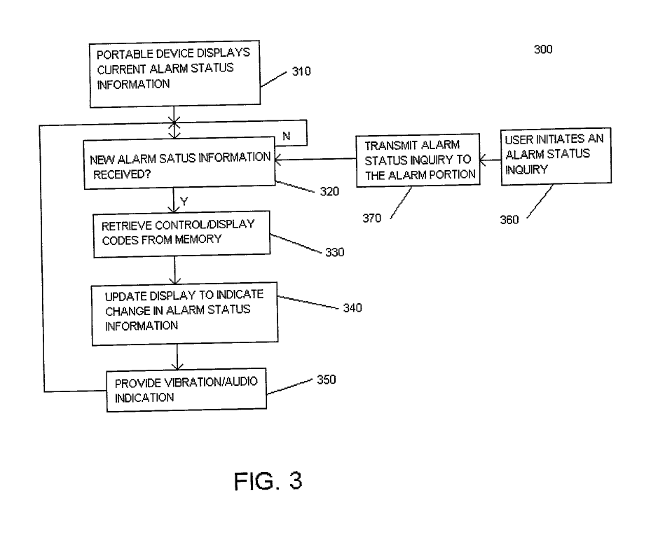

FIG. 3 shows an illustrative operation of an alarm system, such as the alarm system 100 shown in FIG. 1, in accordance with an embodiment of the present invention. In act 310, a processor in a portable device displays a current alarm status of a remotely located alarm portion and monitoring device(s). In act 320, the processor determines whether new alarm status information indicating a change in alarm status is received from the alarm portion via the communication network. As would be obvious to a person of ordinary skill in the art, the processor may not need to perform act 320 if the processor simply waits for a change in alarm status information (e.g., new alarm status information) to be received. In that case, the change in alarm status information may act as an interrupt to halt the processor so that the processor may immediately thereafter perform the further steps illustratively shown in FIG. 3. Since the operation of a processor in performing an instruction is well known in the art, this will not be discussed further herein. If no change in alarm status information is received in act 320, then act 320 may be repeated until a change in alarm status indication is received.

When a change in alarm status information is received in act 320, the processor retrieves from a memory location within a memory, such as the memory 270, a corresponding control/display code during act 330. Thereafter, in act 340, the processor changes the display to indicate the change in alarm status. In act 350, the processor may cause the vibration/audio indicator to vibrate and/or produce an audio indication to notify a user that a change in alarm status has occurred. Thereafter, the processor goes back to act 320 to await any new change in alarm status information.

In one embodiment, a user may optionally perform an alarm status inquiry in act 360 utilizing an inquiry status actuator, such as the inquiry status actuator 210 shown in FIG. 2. In this embodiment, the processor may simply query the memory for stored current alarm status information. In an alternate embodiment wherein the key is equipped with a transmitter, such as the transmitter/receiver 260 shown in FIG. 2, the key may transmit an alarm status inquiry to the alarm portion during act 370 via the communication network. In either event, after the processor receives the current alarm status information, act 330 is performed and operation continues as described herein above.

Finally, the above-discussion is intended to be merely illustrative of the invention. Those having ordinary skill in the art may devise numerous alternative embodiments that are within the scope of the present invention.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope; and

d) several “means” may be represented by the same item or hardware or software implemented structure or function.

The claimed invention is:

1. A portable apparatus comprising:
a receiver configured to receive alarm status information from an alarm portion; and
a processor operatively coupled to the receiver and configured to display an alarm status indication in response to received alarm status information.

2. The apparatus of claim 1, wherein the apparatus is in the form-factor of a key.

3. The apparatus of claim 1, comprising a memory operatively coupled to the processor and configured for storing a plurality of alarm status indication data, wherein said processor is configured to query said memory to retrieve data in response to received alarm status information and is configured to utilize said data to produce said alarm status indication.

4. The apparatus of claim 1, comprising a status inquiry actuator configured to facilitate a user to make an alarm status inquiry, wherein said processor is configured to display the alarm status indication in response to the alarm status inquiry.

5. The apparatus of claim 4, comprising a transmitter configured to provide the alarm status inquiry to the alarm portion.

6. The apparatus of claim 1, comprising a vibration device configured to alert a user by vibrating in response to received alarm status information.

7. The apparatus of claim 1, comprising an auditory device configured to alert a user by producing an auditory signal in response to received alarm status information.

8. An alarm system comprising:
an alarm portion; and
a key wirelessly coupled to the alarm portion and configured to receive alarm status information from said alarm portion and to display an alarm status indication in response to the received alarm status information.

9. The alarm system of claim 8, wherein the key comprises:
a processor; and
a memory, operatively coupled to the processor, and configured for storing display data, wherein said processor is configured to query said memory to retrieve said data in response to received alarm status information and is configured to utilize said data to produce said alarm status indication.

10. The alarm system of claim 8, comprising a status inquiry actuator configured to facilitate a user to make an alarm status inquiry, wherein said processor is configured to display said alarm status indication in response to the alarm status inquiry.

11. The alarm system of claim 10, comprising a transmitter configured to provide the alarm status inquiry to said alarm portion.

12. The alarm system of claim 8, comprising a vibration device configured to alert a user by vibrating in response to the received alarm status information.

13. The alarm system of claim 8, comprising an auditory device configured to alert a user by producing an auditory signal in response to the received alarm status information.

14. The alarm system of claim 8, comprising a monitoring device operatively coupled to said alarm portion and configured to detect a change in alarm status in the proximity of said monitoring device and to transmit corresponding data to said alarm portion, wherein said alarm portion is configured to provide said alarm status information in response to said corresponding data.

15. The alarm system of claim 8, comprising a plurality of monitoring devices, each one of said plurality of monitoring devices being operatively coupled to said alarm portion, being configured to each detect a different change in alarm status, and being configured to transmit corresponding data to said alarm portion, wherein said alarm portion is configured to identify each corresponding data and to provide corresponding alarm status information in response to said corresponding data.

16. The alarm system of claim 8, wherein said alarm portion is configured to continue providing said alarm status information until said key provides a confirmation that said alarm status information is received.

17. The alarm system of claim 8, comprising a communication network coupled between said alarm portion and said key, wherein said communication network is configured to forward said alarm status information from said alarm portion to said key.

18. The alarm system of claim 17, wherein said communication network is configured to continue forwarding said alarm status information to said key until said key transmits a signal to said communication network, and wherein said key is configured to transmit said signal to said communication network after receipt of said alarm status information.
